(19) United States
(12) Patent Application Publication
(10) Pub. No.: US 2007/0060088 A1
(43) Pub. Date: Mar. 15, 2007

(54) Apparatus for automatically adjusting amplitude of audio signal based on background environment

(75) Inventor: Ting-Kuo Kao, Taipei (TW)

Correspondence Address: BIRCH STEWART KOLASCH & BIRCH, PO BOX 747, FALLS CHURCH, VA, 22040-0747, US

(73) Assignee: GIGA-BYTE TECHNOLOGY CO., LTD.

(21) Appl. No.: 11/357,064

(22) Filed: Feb. 21, 2006

(30) Foreign Application Priority Data
Sep. 12, 2005 (TW) 094131277

(51) Int. Cl. H04B 1/10

(52) U.S. Cl. 455/219

(57) ABSTRACT

The invention provides an apparatus that is adapted to adjust the amplitude of an audio signal based on the background. The apparatus, according to a preferred embodiment of the invention, includes an audio receiving module. The audio receiving module is adapted to receive a first audio and a second audio and to generate a process signal including a first signal and a second signal. A processing module extracts the second signal from the process signal. An adjusting module receives the extracted second signal and generates a gain in accordance with the extracted second signal and a criterion. The adjusting module adjusts the amplitude of the audio signal in accordance with the gain.

### BACKGROUND OF THE INVENTION

1. Field of the invention

This present invention relates to an adjusting apparatus for automatically adjusting the amplitude of audio signals; more particularly, the present invention relates to an adjusting apparatus for adjusting the amplitude of audio signals based on the background environment. The present invention includes an audio receiving module, a processing module, and an adjusting module. The processing module is adapted to receive a process signal generated by the audio receiving module. The processing module extracts a signal from the process signal. The adjusting module then generates a gain in accordance with the extracted signal and a criterion and adjusts the amplitude of the audio signal in accordance with the gain.

2. Description of the prior art

Before the present invention was invented, a user adjusts the amplitude of audio signals by the volume control button on the adjusting apparatus. However, the user may miss part of the audio signals while adjusting the volume control button.

If the apparatus is set in a car, the user may have to adjust the volume control button while driving, and a car accident may happen. The adjusting apparatus of the prior art automatically adjusts the amplitude of the audio signals in accordance with the volume generated by the speed of the car. However, the apparatus cannot precisely adjust the amplitude of the audio signal. Moreover, the apparatus, which automatically adjusts the amplitude of the audio signals, cannot be applied in an environment with noise.

Hence, it is necessary to provide an apparatus capable of precisely controlling the volume and adjusting the amplitude of the audio signals based on the background environment.

### SUMMARY OF THE INVENTION

An objective of the invention is to provide an apparatus for adjusting the amplitude of the audio signals based on the background environment. According to a preferred embodiment of the present invention, the problem that the apparatus of the prior art cannot be used in an environment with noise and cannot control volume precisely will be resolved.

The advantage and spirit of the invention may be understood by the following recitations together with the appended drawings.

### BRIEF DESCRIPTION OF THE APPENDED DRAWINGS

FIG. 1 is a function block diagram of an adjusting apparatus according to the preferred embodiment of the invention.

FIG. 2 is a function block diagram an adjusting module according to the preferred embodiment of the invention.

### DETAILED DESCRIPTION OF THE INVENTION

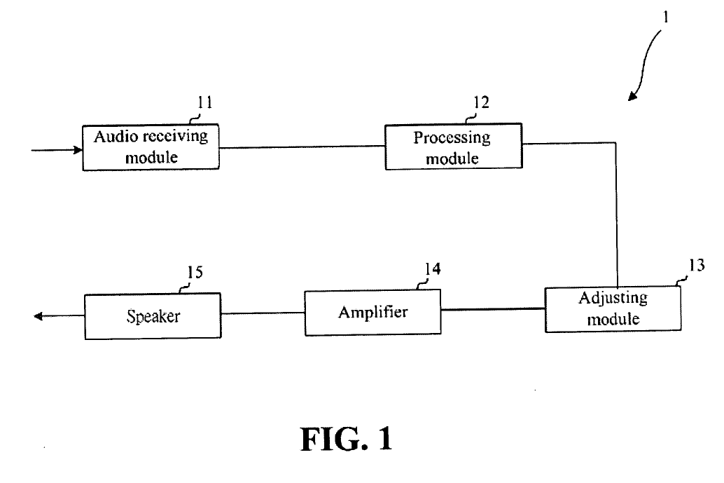

Please refer to FIG. 1. FIG. 1 is a function block diagram of an adjusting apparatus according to the preferred embodiment of the invention. The adjusting apparatus 1 is used in a broadcasting system for broadcasting audio signals. An amplifier 14 is adapted to trigger a speaker 15. The amplifier 14 has a second gain. The amplifier 14 outputs the broadcasted audio signals, according to the second gain, via the speaker 15.

The adjusting apparatus 1 includes an audio receiving module 11. The audio receiving module 11 is adapted to receive a first audio related to the broadcasted audio signals and a second audio relative to the background environment, and it also generates a process signal comprising a first signal, converted from the first audio received by the audio receiving module 11, and a second signal, converted form the second audio received by the audio receiving module 11.

In the embodiment of the present invention, the amplified efficiency of the amplifier is w; the amplified efficiency of the speaker is s. The degree of transmission reduction of sound waves in the air is a. The receiving efficiency of the audio receiving module 11 is m. The total efficiency from the broadcasted audio signal outputting from the amplifier 14, to the audio receiving module 11 receiving the broadcasted audio signal is n, and n equals to masw.

Generally speaking, the output efficiency s of the speaker and the degree of transmission reduction of sound waves in the air a change according to the venue/environment. Therefore, the total efficiency also changes according to different venues.

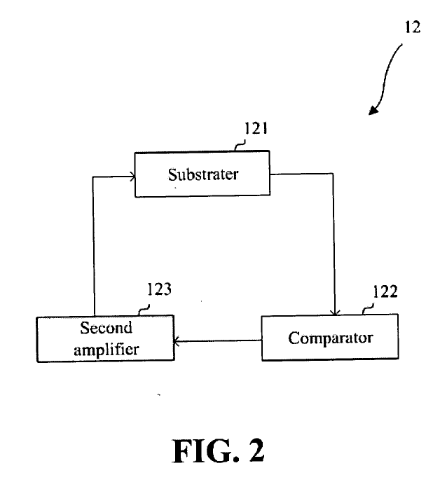

Please refer to FIG. 2. FIG. 2 is a function block diagram of an adjusting module according to the preferred embodiment of the invention. The processing module includes a substrater 121, a comparator 122, and a second amplifier 123. The second amplifier 123 is adapted to amplify the broadcasted audio signal. The substrater 121 is adapted to subtract the process signal from the adjusted audio signal which was amplified by the second amplifier 123. The comparator 122 is adapted to compare the subtracted result with zero. The function of the second amplifier 123 is to simulate the total efficiency of the broadcasted audio signal, outputted from the amplifier 14 to the audio receiving module 11 receiving the audio signal, to n. If the efficiency of the second amplifier 123 is n1, and the result of the substrater 121 is zero, then n equals to n1.

If the result of the substrater 121 is not zero, then the second amplifier 123 adjusts its efficiency to n2 until the subtraction of the process signal and the simulated efficiency of the second amplifier 123 is zero. Hence, the second signal is derived from the substration of the process signal and the output of the second amplifier 123 by the processing module 12.

As shown in FIG. 1, the adjusting module 13 receives the extracted second signal and the audio signal, generates a gain in accordance with the extracted second signal and a criterion, and adjusts the amplitude of the audio signal in accordance with the gain

As compared to the prior art, the invention provides an apparatus for precisely controlling the volume and for automatically adjusting the amplitude of the audio signals based on the background environment

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. In a broadcasting system for broadcasting an audio signal, an adjusting apparatus for adjusting an amplitude of the audio signal based on a background, said adjusting apparatus comprising:
an audio receiving module for receiving a first audio relative to the broadcasted audio signal and a second audio relative to the background, and generating a process signal comprising a first signal converted from the received first audio and a second signal converted form the received second audio;
a processing module for receiving the audio signal and the process signal, and extracting the second signal from the process signal by using the process signal and the audio signal; and
an adjusting module for receiving the extracted second signal and the audio signal, generating a gain in accordance with the extracted second signal and a criterion, and adjusting the amplitude of the audio signal in accordance with the gain.

2. The adjusting apparatus of claim 1, wherein the processing module comprises a substrater, a comparator, and an amplifier; the amplifier is adapted to adjust a second amplitude of the broadcasted audio signal, the substrater is adapted to subtract the process signal from the adjusted audio signal, and the comparator is adapted to compare the subtracted result with zero.
